(19) United States
(12) Patent Application Publication
(10) Pub. No.: US 2016/0044459 A1
(43) Pub. Date: Feb. 11, 2016

(54) COMMUNICATION METHOD AND SYSTEM

(71) Applicant: Peris Muchina, St. Louis Park, MN (US)

(72) Inventor: Peris Muchina, St. Louis Park, MN (US)

(21) Appl. No.: 14/663,363

(22) Filed: Mar. 19, 2015

Related U.S. Application Data
(60) Provisional application No. 61/955,590, filed on Mar. 19, 2014.

(51) Int. Cl. H04W 4/02; H04W 8/20

(52) U.S. Cl. CPC H04W 4/023; H04W 8/20; H04W 4/22

(57) ABSTRACT

A method for enabling communication between a first person in need of assistance and an emergency responder including providing a personal device for being carried or kept by the first person, wherein the device includes a wireless transmitter and an actuator usable by the person to cause the transmitter to send a first signal, and providing a second device configured to receive the first signal, determine location of the first person, determine location of at least one emergency responder in proximity to the personal device, and provide a second signal to the at least one emergency responder.

### CROSS-REFERENCE TO RELATED APPLICATION

This application claims priority to Provisional Application No. 61/955,590, filed Mar. 19, 2014, which is herein incorporated by reference in its entirety.

### TECHNICAL FIELD

The present disclosure relates to mobile devices that communicate with an emergency responder when a device user is faced with an emergency situation.

### BACKGROUND

Existing mobile devices include functionality for communicating to a pre-selected list of emergency contacts via phone calls and text messaging over existing mobile and wireless internet networks. Existing devices also permit phone calls to be made to central emergency response systems. Certain existing devices also include functionality for determining the location of the device and transmitting that information to the pre-selected emergency contacts. With existing devices emergency response times are dependent on communicating emergency distress signals and information to a central responder or emergency contact. When the information is received by an emergency contact, the contact then communicates with emergency responders to relay this information. When a central responder receives the communication, the responder first identifies the nature of the emergency and confirms the location of the individual undergoing the emergency through verbal communications with the device user. The central responder then identifies the location of the nearest emergency response personnel and directs them to the location of the emergency.

### SUMMARY

The present disclosure provides a system, devices, components and methods for communications between a person in need and one or more emergency responders. One such emergency communication system is usable by a first person who might need of assistance from an emergency responder. It can include a personal device for being carried or kept by the first person, wherein the device includes a wireless transmitter and an actuator usable by the person to cause the transmitter to send a first signal. It can also include a second device configured to receive the first signal, determine location of the first person, determine location of at least one emergency responder in proximity to the personal device, and provide a second signal to the at least one emergency responder. Various other components, aspects, means and devices can be used with such a system.

One such method is enabling communication between a first person in need of assistance and an emergency responder. It can include providing a personal device for being carried or kept by the first person, wherein the device includes a wireless transmitter and an actuator usable by the person to cause the transmitter to send a first signal. It can further include providing a second device configured to receive the first signal, determine location of the first person, determine location of at least one emergency responder in proximity to the personal device, and provide a second signal to the at least one emergency responder. Various other components, aspects, means, devices and steps can be used with such method.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of the disclosure, and the manner of attaining them, will become more apparent and will be better understood by reference to the following description of embodiments of the disclosure taken in conjunction with the accompanying drawings, wherein:

FIG. 1 is a perspective top view of a first device and a second device, according to one embodiment.

Corresponding reference characters indicate corresponding parts throughout the several views. The exemplifications set out herein illustrate embodiments of the disclosure and such exemplifications are not to be construed as limiting the scope of the invention in any manner.

### DETAILED DESCRIPTION

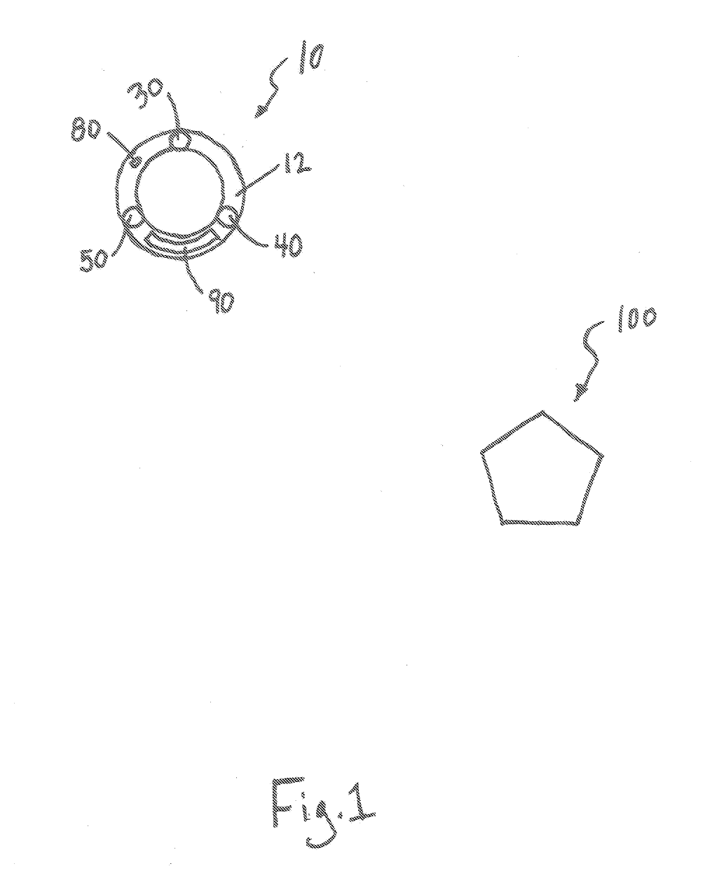

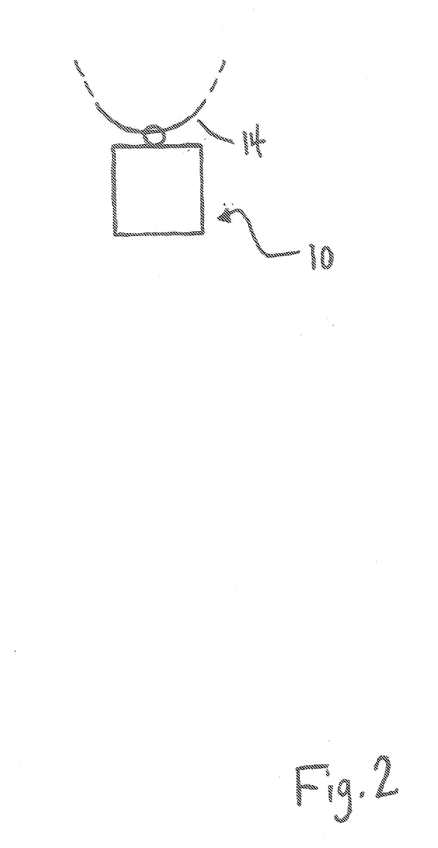

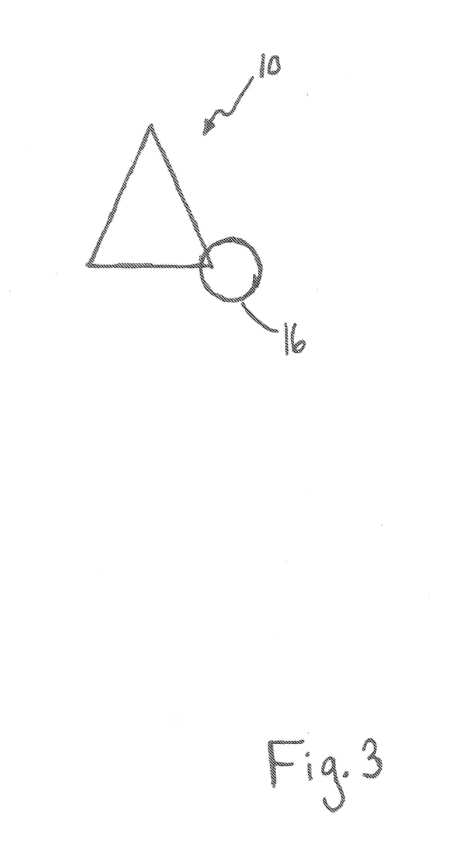

Referring now to the embodiment shown in FIG. 1, a first device 10 and a second device 100 are shown. The first device 10 is enclosed in a housing 12 that can be configured to be worn in a number of configurations. In this embodiment, the first device 10 is designed in a circle to be worn by the user around the wrist, ankle or neck, such as a bangle.

Another embodiment of the first device 10 is shown in FIG. 2, in which the first device 10 can be configured to be worn on a lanyard or necklace 14.

Another embodiment of the first device 10 is shown in FIG. 3 in which it can be attached to a user's clothing or bag (not shown). In this embodiment, the housing 12 includes an adjustable clasp 16 to adjust the size for different users. The housing 12 protects the internal electronics (not shown) of the first device 10 which, in this embodiment, includes means for obtaining location information of the device such as known global positioning electronics (not shown) and means for transmitting information about the location of the device or the person and/or information about the person such as transmitters used in known devices, for example, electronics used in commercially available emergency alert devices like the Life Alert® devices. Similarly, the first device can include means for transmitting text and voice communications over existing mobile communication and internet networks using known electronics in mobile phones (such as Apple iPhone® devices, two-way radios (such as Motorola Talkabout® devices), and other known devices.

Referring back to the embodiment shown in FIG. 1, the housing 12 includes first, second and third buttons 30, 40, 50. In this embodiment, first button 30 is used to communicate location and text or voice communications to emergency response personnel, including to both central emergency response systems and to emergency response personnel in the vicinity of or proximity to the device using the location acquisition and transmission functions of the device. In this embodiment, second and third buttons 40, 50 are used to communicate location and text or voice communications to emergency contacts selected by the user. The buttons can be used to contact different types of responders such as those previously described. The text and/or voice communications can allow the first person to provide specific information about the situation or that a button was pushed or actuated inadvertently such that no response is needed.

The first device 10 can also include a known microphone 60 for voice communications and known text electronics for acquiring and transmitting text messages sent by the user or transcribed by the device from the user's spoken words and a speaker 70 to allow the user to hear communications from emergency response personnel and emergency contacts. Voice recognition software such as Dragon® software can be implemented as well.

A digital display 80 provides device information and displays text, graphics and other information regarding communications to and from the device and may include a touch screen (not shown).

A USB port or other port 90 allows for charging the device's rechargeable battery(ies) (not shown) and for connecting the device to a computer or other device (not shown) to facilitate set up, maintenance, updating and use of the device through communications between the mobile device and the computer or other device.

In this embodiment, the buttons 30, 40, 50 and the display 90 are protected by the housing 12 that includes a removable cover 100. In another embodiment the display can for example be protected by glass or polymer coatings used in the mobile device field (not shown).

The second device 100 can be one device including one or more known electrical and/or electronic components or can be a group of multiple devices that work together. Such components or devices can include known signal receivers and transmitters, processors, controllers, data storage, memory, power sources, circuit boards, and connectors. Such known components are used in various known devices including mobile phones, personal computers, data storage drives, memory cards, programmable controllers. The programming of these components/devices to carry out the disclosed methods is also known.

Aspects described above and other aspects can be used to provide an emergency communication system 150 that is usable by a first person who might need of assistance from an emergency responder, which can be an EMT (emergency medical technician), doctor, nurse, police officer, other security personnel, fire personnel and the like). The system can include a personal device (e.g., first device 10) for being carried or kept by the first person. The device 10 can include a known wireless transmitter and a known actuator, e.g., previously described buttons that can be made of various types of known switches such as membrane switches or touch screen locations. They are usable by the person to cause the transmitter to send a first signal. The second device, such as the previously described embodiments, can be configured to receive the first signal, determine location of the first person, determine location of at least one emergency responder in proximity to the personal device, and provide a second signal to the at least one emergency responder, or one or more of the above.

The second device can be configured to not require a second person to do one or more of to receive the first signal, determine the location of the person, determine locations of emergency responders in proximity to the personal device or provide a second signal to an emergency responder. The second device is configured or programmed to select a particular emergency responder of the at least one emergency responder in proximity of the first person. The system 150 can be configured, for example, such that proximity is one of within a 100-mile radius, a 10-mile radius, a 5-mile radius or even less.

The system personal device can be configured such that the first signal provides information about the first person. The information about the first person can include at least one of the first person's identity, age, medical condition, medication, home address, work address, phone number, emergency contact, physician, family, and preference. Still other information is contemplated.

The second device 100 can be configured or programmed such that the second signal provides information about the first person including at least one of the first person's identity, age, medical condition, medical history, medication, home address, work address, phone number, emergency contact person, physician, family, and preference. The second device can be configured or programmed to receive any of the information about the first person from at least one of a hard drive, flash drive, magnetic tape, and another known data storage device means. Alternatively or in addition, the second device can be configured programmed to receive any of the information about the first person from the first signal.

The second device can be configured to receive confirmation of receipt of the second signal by an emergency responder and to provide the second signal or another signal to a different emergency responder in the event the confirmation of receipt is not received within a period of time.

The second device can be configured or programmed to provide a third signal to an emergency contact person of the first person. The third signal can merely alert the contact person that the first device has been actuated by the first person or can carry information about the device and/or person including location, text, etc. Similarly, the second device can be configured to transmit to a hospital location information about the first device and/or the first person.

The first device 10 can further include other known components or devices including a display to assist in communication and the display of device information, a touch screen, rechargeable battery, and a port for exchanging information with at least one of a personal computer, a central computer, a process controller, a data storage device, and a connector for attaching the first device to the first person.

The second device 100 can be portable by or with an emergency responder. And as noted previously, rather than a single second device, the system can comprises multiple portable devices that can be carried by or with multiple emergency responders. For example, all or some number of emergency responders in a small town can carry or have near a second device. 16. Again, each second device can include multiple known components or means to receive the first signal, determine location of the first person, determine location of at least one emergency responder in proximity to the personal device, and provide a second signal to the at least one emergency responder.

Still another embodiment is a method for enabling communication between a first person in need of assistance and an emergency responder. The method can include providing a personal device for being carried or kept by the first person wherein, for example, the device includes a wireless transmitter and an actuator usable by the person to cause the transmitter to send a first signal. The method can also include providing a second device configured to receive the first signal, determine location of the first person, determine location of at least one emergency responder in proximity to the personal device, and provide a second signal to the at least one emergency responder. This method can be carried out using the various previously described embodiments. Again, the second device can be configured to not require a second person to receive the first signal, determine the location of the person, determine locations of emergency responders in proximity to the personal device and/or provide a second signal to an emergency responder. The second device can be configured to select a particular emergency responder of the at least one emergency responder in the vicinity of the first person. The personal device can be configured such that the first signal provides information about the first person. The information about the first person can include at least one of the first person's identity, age, medical condition, medication, home address, work address, phone number, emergency contact, physician, family, and preference. The second device can be configured such that the second signal provides information about the first person including at least one of the first person's identity, age, medical condition, medical history, medication, home address, work address, phone number, emergency contact person, physician, family, and/or preference. The second device can be configured to receive any of the information about the first person from at least one of a hard drive, flash drive, magnetic tape, and another known data storage device means. The second device can be configured to receive any of the information about the first person from the first signal. The second device can configured to receive confirmation of receipt of the second signal by the emergency responder and to provide the second signal to a different emergency responder in the event the confirmation of receipt is not received within a period of time. The second device can be configured to provide a third signal to an emergency contact person of the first person.

In addition to the multiple previously described embodiments of the method, the second device can be configured to transmit to hospital location information about at least one of the device and the first person. Further, the first device can also include at least one of a display to assist in communication and the display of device information, a touch screen, rechargeable battery, and a port for exchanging information with at least one of a personal computer, a central computer, a process controller, a data storage device, and a connector for attaching the first device to the first person. Also, the second device can be portable such that the second device can carried by or with an emergency responder. Likewise, rather than a single second device, multiple portable devices can be carried by or with multiple emergency responders.

While this disclosure has been described as having exemplary designs and embodiments with various aspects, the present disclosure can be further modified within the spirit and scope of this disclosure. This application is therefore intended to cover any variations, uses, or adaptations of the disclosure using its general principles, including different combinations or permutations of the various aspects in the embodiments. Further, this application is intended to cover such departures from the present disclosure as come within known or customary practice in the art to which this disclosure pertains and which fall within the limits of the appended claims.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. An emergency communication system usable by a first person who might need of assistance from an emergency responder comprising:
a personal device for being carried or kept by the first person, wherein the device includes a wireless transmitter and an actuator usable by the person to cause the transmitter to send a first signal; and
a second device configured to receive the first signal, determine location of the first person, determine location of at least one emergency responder in proximity to the personal device, and provide a second signal to the at least one emergency responder.

2. The system of claim 1, wherein the second device is configured to not require a second person to receive the first signal, determine the location of the person, determine locations of emergency responders in proximity to the personal device or provide a second signal to an emergency responder.

3. The system of claim 1, wherein the second device is configured to select a particular emergency responder of the at least one emergency responder in the vicinity of the first person.

4. The system of claim 1, wherein proximity is one of within a 100-mile radius, a 10-mile radius, or a 5-mile radius.

5. The system of claim 1, wherein the personal device is configured such that the first signal provides information about the first person.

6. The system of claim 1, wherein the information about the first person includes at least one of the first person's identity, age, medical condition, medication, home address, work address, phone number, emergency contact, physician, family, and preference.

7. The system of claim 1, wherein the second device is configured such that the second signal provides information about the first person including at least one of the first person's identity, age, medical condition, medical history, medication, home address, work address, phone number, emergency contact person, physician, family, and preference.

8. The system of claim 7, wherein the second device is configured to receive any of the information about the first person from at least one of a hard drive, flash drive, magnetic tape, and another known data storage device means.

9. The system of claim 7, wherein the second device is configured to receive any of the information about the first person from the first signal.

10. The system of claim 1, wherein the second device is configured to receive confirmation of receipt of the second signal by the emergency responder and to provide the second signal to a different emergency responder in the event the confirmation of receipt is not received within a period of time.

11. The system of claim 1, wherein the second device is configured to provide a third signal to an emergency contact person of the first person.

12. The system of claim 1, wherein the second device transmits to a hospital location information about at least one of the device and the first person.

13. The system of claim 1, wherein the first device further includes at least one of a display to assist in communication and the display of device information, a touch screen, rechargeable battery, and a port for exchanging information with at least one of a personal computer, a central computer, a process controller, a data storage device, and a connector for attaching the first device to the first person.

14. The system of claim 1, wherein the second device is portable by or with an emergency responder.

15. The system of claim 1, wherein the second device can comprises multiple portable devices that can be carried by or with multiple emergency responders.

16. The system of claim 1, wherein the second device includes multiple components to receive the first signal, determine location of the first person, determine location of at least one emergency responder in proximity to the personal device, and provide a second signal to the at least one emergency responder.

17. A method for enabling communication between a first person in need of assistance and an emergency responder, comprising:
providing a personal device for being carried or kept by the first person, wherein the device includes a wireless transmitter and an actuator usable by the person to cause the transmitter to send a first signal; and
providing a second device configured to receive the first signal, determine location of the first person, determine location of at least one emergency responder in proximity to the personal device, and provide a second signal to the at least one emergency responder.

18. The method of claim 17, wherein the second device is configured to not require a second person to receive the first signal, determine the location of the person, determine locations of emergency responders in proximity to the personal device or provide a second signal to an emergency responder.

19. The method of claim 17, wherein the second device is configured to select a particular emergency responder of the at least one emergency responder in the vicinity of the first person.

20. The method of claim 17, wherein proximity is one of within a 100-mile radius, a 10-mile radius, or a 5-mile radius.

21. The method of claim 17, wherein the personal device is configured such that the first signal provides information about the first person.

22. The method of claim 17, wherein the information about the first person includes at least one of the first person's identity, age, medical condition, medication, home address, work address, phone number, emergency contact, physician, family, and preference.

23. The method of claim 19, wherein the second device is configured such that the second signal provides information about the first person including at least one of the first person's identity, age, medical condition, medical history, medication, home address, work address, phone number, emergency contact person, physician, family, and preference.

24. The method of claim 23, wherein the second device is configured to receive any of the information about the first person from at least one of a hard drive, flash drive, magnetic tape, and another known data storage device means.

25. The method of claim 23, wherein the second device is configured to receive any of the information about the first person from the first signal.

26. The method of claim 17, wherein the second device is configured to receive confirmation of receipt of the second signal by the emergency responder and to provide the second signal to a different emergency responder in the event the confirmation of receipt is not received within a period of time.

27. The method of claim 17, wherein the second device is configured to provide a third signal to an emergency contact person of the first person.

28. The method of claim 17, wherein the second device transmits to hospital location information about at least one of the device and the first person.

29. The method of claim 17, wherein the first device further includes at least one of a display to assist in communication and the display of device information, a touch screen, rechargeable battery, and a port for exchanging information with at least one of a personal computer, a central computer, a process controller, a data storage device, and a connector for attaching the first device to the first person.

30. The method of claim 17, wherein the second device is portable such that the second device can carried by or with an emergency responder.

31. The method of claim 17, wherein the second device can comprises multiple portable devices that can be carried by or with multiple emergency responders.

32. The method of claim 17, wherein the second device includes multiple components to receive the first signal, determine location of the first person, determine location of at least one emergency responder in proximity to the personal device, and provide a second signal to the at least one emergency responder.

33. The method of claim 17, wherein the second device further includes additional devices.
